(19) United States
(12) Patent Application Publication
(10) Pub. No.: US 2002/0140623 A1
(43) Pub. Date: Oct. 3, 2002

(54) Apparatus and method for increasing monopole capacity using internal strengthening

(76) Inventor: John W. Harrison, Stilwell, KS (US)

Correspondence Address: Shughart Thomson & Kilroy, P.C., Twelve Wyandotte Plaza, 120 West 12th Street, Kansas City, MO, 64105, US

(21) Appl. No.: 09/822,046

(22) Filed: Mar. 30, 2001

(51) Int. Cl. H01Q 1/12; H01Q 9/34

(52) U.S. Cl. 343/898; 343/874

(57) ABSTRACT

An existing monopole is strengthened to accommodate loading associated with additional elements included in over-the-air communications systems by placing expanding foam and aggregate, light weight aggregate concrete, normal weight aggregate concrete or other types of fill material into the hollow bore in the interior of the monopole. Monopole strengthening may equire base plate strengthening, adding anchor bolts and/or foundation strenghtening. This permits an existing monopole to accommodate more elements than were initially envisioned when the monopole was initially erected.

### CROSS REFERENCE TO RELATED APPLICATIONS

The present disclosure is related to the application titled APPARATUS AND METHOD FOR INCREASING MONOPOLE CAPACITY USING EXTERNAL STRENGTHENING filed concurrently herewith by the same inventive entity. The disclosure of such related patent application is incorporated herein by reference.

### BACKGROUND OF THE INVENTION

Antennas for over-the-air communications, such as cellular telephone systems, are usually supported on hollow tubular steel monopoles. Monopoles are located throughout most metropolitan and suburban areas. The location and density of monopoles in any particular area depend on the density of users, the elevation of the monopole sites, the height of each monopole and the coverage required. The height of each monopole can vary from only a few feet up to hundreds of feet.

As areas have more and more over-the-air communication demands, monopoles are becoming more and more ubiquitous. Many neighborhoods are resisting the installation of monopoles with great vigor. In addition to the resistance to installation of new monopoles, many of the prime sites for monopoles have already been acquired and are thus not available for new entrants into the field, or for upgrading of an existing system. Many remaining sites are less desirable for companies seeking to enter or expand in the field of over-the-air communication. Reacting to pressure from constituents, many local governments are reluctant to grant permits for new monopoles.

Therefore, there is a need for a means for increasing over-the-air coverage while meeting the requirements placed on locating monopoles.

One way of increasing the over-the-air coverage is to increase the number of antennas available for such coverage. In view of the restrictions placed on adding new monopoles, this will require adding antennas to existing monopoles. It is possible to achieve this end using new antenna technology whereby new antennas do not need to be located as high as antennas embodying older technology. Thus, new antennas could be simply mounted onto existing monopoles and this will achieve the goal of increasing antenna coverage for an over-the-air system without requiring the placement of more monopoles.

However, this approach is not as simple as it appears at first blush. The problem with adding more antennas to an existing monopole is that such addition of antennas increases the loading on the monopole. Loading on the monopole is increased both from a dead load standpoint and from a live load standpoint.

Thus, simply adding more antennas to a monopole will increase the load on the monopole by the addition of the weight associated with the additional antennas. This weight is manifested in added compression stresses placed on the monopole.

Another problem associated with adding antennas to an existing monopole is that live loads on the monopole associated with wind loading on the antennas (both the existing antennas and the newly added antennas) will be increased by a factor determined by the wind area added to the monopole.

It is also noted that wind forces on the antennas can also cause a twisting stress on the monopole, and this stress will also be increased by the addition of antennas to the existing monopole.

The wind forces on the antennas creates both live loading on the monopole and may create a possibility of misaligning antennas. Misalignment of one antenna can be created by wind loading on other antennas on the same monopole due to the twisting or deflection of the monopole associated with such wind forces on the monopole and other antennas.

Yet another problem with simply adding antennas to an existing monopole arises because many existing monopoles have been designed for loads associated with a certain number of antennas. Thus, adding antennas and the forces associated with those additional antennas may create a situation for some existing monopoles in which the loading on the monopole is not within design parameters.

Therefore, there is a need for apparatus and methods for increasing the number of antennas that can be supported on an existing monopole whereby advantage can be taken of new antenna technology without exceeding the design limits of existing monopoles.

It may also not be possible to simply re-enforce existing monopoles by purchasing additional land to accommodate the guy wires or the like. Many municipalities have aesthetic requirements that will be violated by such guys, and some monopole sites are not large enough to include such guys. Still further, adding guys may be so expensive that it overwhelms the cost savings associated with the addition of antennas.

Therefore, there is a need for an apparatus and methods for increasing the number of antennas that can be supported on an existing monopole without requiring guy re-enforcement of the monopole.

Of course, one approach to accommodating additional antennas would be to simply replace existing monopoles with new and stronger monopoles. However, this approach may prove to be too costly to be feasible.

Therefore, there is a need for a means and a method for modifying existing monopoles to accommodate additional antennas without requiring replacement of such existing monopoles.

### SUMMARY OF THE INVENTION

The inventive entity of the present invention has observed that existing monopoles are generally hollow tubular structures. These structures have been designed according to deflection limitations or to allowable stress placed on the wall of the tubular structure. The inventive entity has also observed that design calculations indicate that design stresses are well under allowable stresses when the design is based on deflection. Therefore, there will be strength available if the monopole can be stiffened to reduce deflection when antennas are added to the structure.

When design limits associated with hollow tubular structures such as monopoles are based on stress, the allowable stress is based on compression failure rather than tension failure. When antennas supported on a monopole are subject to wind forces, the forces transferred to the monopole are manifested in tension forces on some parts of the structure wall and in compression forces on other parts of the structure wall. It has also been observed that the forces associated with the weight of the antennas and the monopole are compression forces and thus added to the compression forces associated with wind loading on the antennas and the monopole. This will exacerbate any problems that may be associated with compression forces applied to the monopole. Still further exacerbating the problem is the observed fact that allowable stress associated with compression is generally less than the yield point stress which is associated with allowable stress using tension as a design criterion. It is also noted that adding guys generally does not increase the structure's ability to accommodate compressive loading.

The steel used in monopoles is high strength steel. When the design of such monopoles is based on deflection, the steel is often stressed to less than seventy per cent of the yield point stress of the steel. Plate used for bent plate structures commonly has a yield point of sixty-five thousand pounds per square inch (psi). However, the allowable stress, when compression governs, is often about fifty-two thousand psi. Thus, if it is possible to retrofit an existing monopole that has been designed using limits associated with compression to actually be limited by tension instead, an additional percentage (in the case presented above, an additional twenty-five per cent) in design limits could be gained. Further, if mill tests for plates in a particular structure are available, it may be possible to determine that the yield point stress exceeds the minimum specified value thereby creating an opportunity to further increase the design limits associated with an existing monopole. As can be understood from the teaching of the above discussion, increasing the design limits of an existing monopole will permit that monopole to support additional antennas without requiring guys or the like or without requiring replacement of existing monopoles.

The present inventive entity has discovered that the design limits of an existing monopole can be increased by strengthening the monopole in its ability to accommodate compressive loading. This increase of strength in compression thus permits the design limits to be based on tension rather than compression. As discussed above, the allowable stress associated with compression is generally less than the yield point stress which would be the allowable stress if tension governs the design. This thus increases the load carrying capacity of a monopole.

Thus, the present invention overcomes the above-discussed problems and drawbacks by increasing the compression limits of an existing monopole by supporting the compression faces and by increasing its section modulus which allows more load-carrying capacity. One form of the invention achieves this goal by placing filler material that is strong in compression inside the monopole.

This takes advantage of the fact that most existing monopoles are hollow. By increasing the compression design limits of a monopole, expense and effort are directed to the most efficient use of resources and are not wasted on increasing design limits that are not as efficiently utilized for increasing compression limits.

Still further, increasing the compression limits of an existing monopole by filling the monopole with material that is strong in compression takes advantage of the fact that most existing monopoles are already hollow and the filler material can be installed in an economical manner. Still further, using the hollow nature of existing monopoles to add strengthening material internally to the monopole permits strengthening the monopole without endangering the aesthetics of such poles that have already been approved. Thus, the inventive means and method of the present invention is a way of increasing the design limits of an existing monopole in a manner that is both efficient and economical thereby increasing the strength of a monopole to accommodate additional antennas becomes economically feasible.

The present invention also includes strengthened base plates and foundations supporting monopoles.

### TECHNICAL FIELD OF THE INVENTION

The present invention relates to the general art of static structures, and to the particular field of monopoles.

### OBJECTS AND ADVANTAGES OF THE INVENTION

It is a main object of the present invention to provide a means for increasing over-the-air coverage while meeting the requirements placed on locating monopoles.

It is another object of the present invention to provide an apparatus and methods for increasing the number of antennas that can be supported on an existing monopole without requiring guy re-enforcement of the monopole.

It is another object of the present invention to strengthen an existing monopole without changing the aesthetics of the existing monopole.

It is another object of the present invention to strengthen an existing monopole by adding strengthening material internally of the monopole.

It is another object of the present invention to strengthen an existing monopole in the most efficient and cost effective manner.

It is another object of the present invention to provide a means and a method for modifying existing monopoles to accommodate additional antennas without requiring replacement of such existing monopoles.

It is a more specific object of the present invention to strengthen an existing monopole by increasing the design limit that is most effective in providing the overall increase in design limits that will be most effective and efficient to increase the load carrying capacity of the monopole.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is an elevational view of one form of a monopole.

FIG. 2 is an elevational view of another form of a monopole.

FIG. 3 is a sketch that illustrates loading on a monopole subject to wind forces.

FIG. 4 is an elevational view of one form of a monopole that has been modified and strengthened according to the teaching of the present invention.

FIG. 5 is an elevational view of another form of a monopole that has been modified and strengthened according to the teaching of the present invention.

FIG. 6 is a top plan view of a base of a monopole.

FIG. 7 is an elevational view of a base of a monopole.

FIG. 8 is a top plan view of a template used in a base of a monopole.

FIG. 9 is a partial view of a multi-sided monopole which has been strengthened by affixing strengthening elements to the outside surface, or surfaces, of the monopole.

FIG. 10 is an enlarged view of a portion of the monopole shown in FIG. 9.

FIG. 11 is a cross-section of a twelve-sided pole.

FIG. 12 is an enlarged view of FIG. 10.

FIG. 13 is similar to FIG. 12 but with an access flange through which internal cables pass into a pole.

FIGS. 14-16 are similar to FIGS. 11-13 respectively, showing a monopole that is circular in perimetric shape.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

It is noted that the present disclosure will refer to antennas or antenna structures. It is intended that the term “antenna” will cover any element used in over-the-air communication systems, including microwave dishes, supporting platforms and the like and it is not intended to limit the scope of this invention to antennas per se. It is also intended that the broad term “over-the-air communication system” covers cellular telephone systems as well as any other such system.

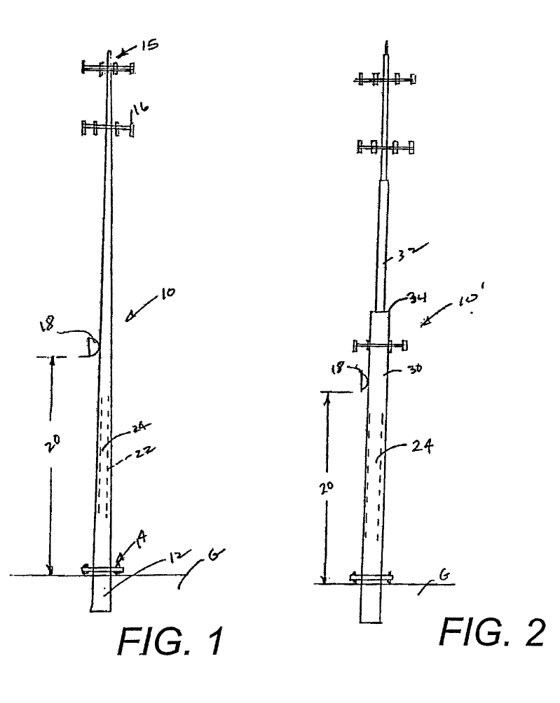

Two types of existing monopoles are shown in FIGS. 1 and 2. Both monopoles are tubular and hollow and are formed of steel to have a hollow interior and are anchored at the base thereof in the ground. One type of existing monopole is unitary and is shown in FIG. 1 as monopole 10. Monopole 10 has a base 12 that is cast in ground G and a base assembly 14. Monopole 10 extends upward from ground G and tapers to a top area 15. As indicated, monopole supports a variety of elements that are associated with over-the-air communication systems, such as antennas 16, dishes 18 and the like. These elements are positioned on monopole 10 at levels above the ground, indicated by level 20 which corresponds to the lowest level of the elements existing on the monopole. One form of existing monopole is one hundred fifty feet tall, has a fourteen inch top diameter and a sixty inch base diameter. Antennas are located at the one hundred fifty foot level and at the one hundred thirty foot level, with the one hundred thirty foot level being indicated as level 20.

Monopole 10 is hollow as indicated by dotted lines 22 to define an inner bore 24 and has been designed to safely support the communications elements in position to effectively carry out the functions associated with such elements in over-the-air communications systems. Thus, design stresses, yield points, and the like have been selected to achieve this goal.

An alternative form of monopole 10′ is shown in FIG. 2 as including a plurality of sections, such as sections 30 and 32, that have outside diameters differing from each other to produce a stepped shape with a shoulder 34 between adjacent sections. Otherwise, monopole 10′ is identical to monopole 10 and includes a hollow bore 24′ and supports elements such as an antenna dish 18 at a first level, with the lowest level element being at a level 20 above the ground. Other forms of monopoles may occur to those skilled in the art based on the disclosure herein and these additional types of monopoles are also intended to be included in the scope of this disclosure and invention.

For convenience, the elements on the monopoles as these monopoles exist prior to being modified according to the teaching of the present invention to support additional elements will be referred to as first elements. Elements added to the existing monopoles to accommodate additional traffic in over-the-air communications systems will be referred to as second elements.

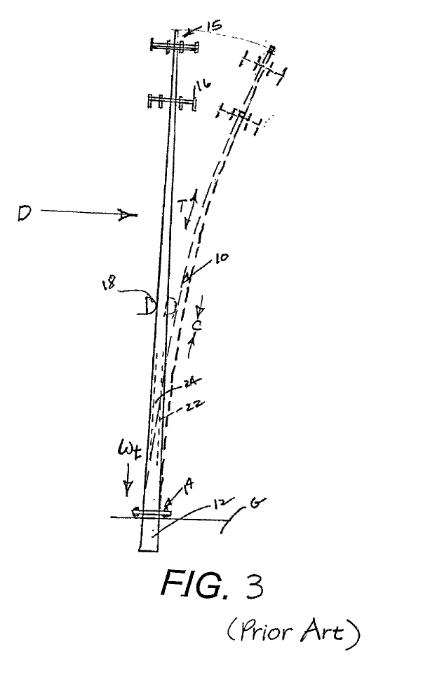

Referring to FIG. 3, the various forces of interest to this disclosure are identified. Thus, the wall W of monopole M is subject to a force associated with the weight Wₜ which manifests itself as a compressive force C on the wall of the hollow monopole. As the structure is exposed to wind D, the pole deflects in direction X from vertical. Due to this deflection, various portions of the monopole wall are subjected to forces. Thus, one portion T1 of wall W is subject to tension T due to the deflection of the monopole, while another portion C1 of wall W is subject to compression force C2. This compression force is added to the compression force C associated with the weight of the monopole and the elements supported thereon.

As discussed above, the inventive entity of the present invention has discovered that if the design of an existing monopole can be controlled by tension, there is additional bending capacity that can be utilized so more antennas can be installed on an existing monopole that has been thus modified. This is achieved by adding elements to the existing monopole that adds to the strength of the monopole in regard to compression.

Accordingly, the best mode of the present invention includes placing a filler element that is strong for compression forces inside the hollow bore of the existing monopole. Specifically, the best mode of the present invention includes placing expanding foam and aggregate, lightweight aggregate concrete normal aggregate concrete or the like in the bore of the hollow existing monopole. The concrete is the most efficient and economical element that can be used to achieve the purposes of this invention. One form of the aggregate used for this concrete is manufactured under the trademark HADITE. Other types of concrete, including that which uses standard weight aggregate, can also be used as will occur to those skilled in the art based on the teaching of the present disclosure. These additional types of fills and concrete are intended to be included in the scope of this invention as well.

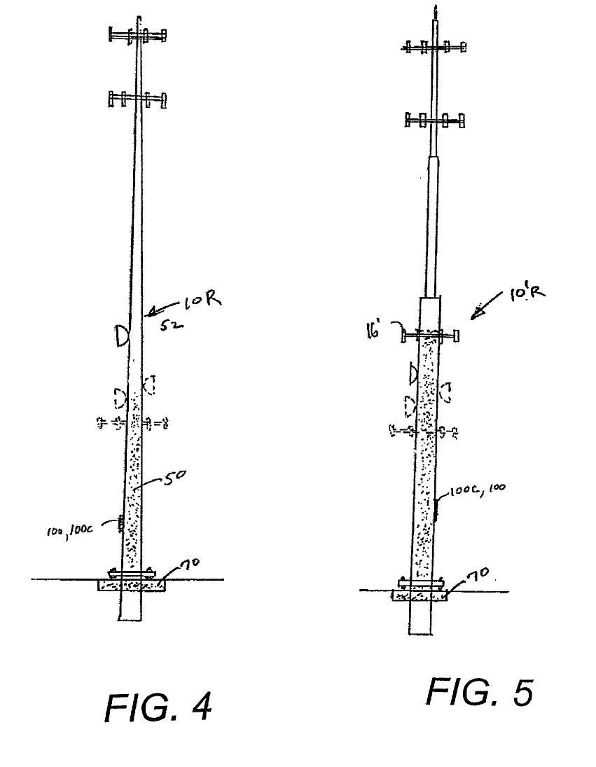

Referring to FIGS. 4 and 5, it can be seen that monopole 10 is modified to monopole 10R, or retrofit, by locating filler material 50 into the hollow bore 24 as by flowing the filler into the bore via a hole defined through the wall of the pole, or the like. The filler material is filled in the bore to a level 52. While this level can vary according to the factors associated with each monopole, the best mode of the present invention includes level 52 being essentially co-level with the level of the lowest element of the first elements existing on the monopole before the monopole is modified to include the filler material. That is, level 52 is essentially co-level with level 20.

Once filler material 50 is in place, additional elements, 16′ and/or 18′ can be added to the monopole. These additional, or second, elements can be located at levels that are lower than levels 20 and/or 52 because they are manufactured using technology that is newer than the technology used for first elements 16 and/or 18. However, it may be possible to add antennas above the first elements.

Referring to FIG. 5, it is seen that monopole 10′ is modified, or retrofit, as monopole by locating filler material 50 in bore 24 of monopole 10′ to level 52′ that is co-level with antennas 16′. Antennas 16′ are located at a level that is above level 20; however, this is illustrated to emphasize that the actual level of the filler material is dictated by the particular conditions associated with the particular monopole being modified. The level of the concrete will depend on the added antennas and the specific pole and any other appropriate design criteria as will be understood by those skilled in the art based on the teaching of this disclosure.

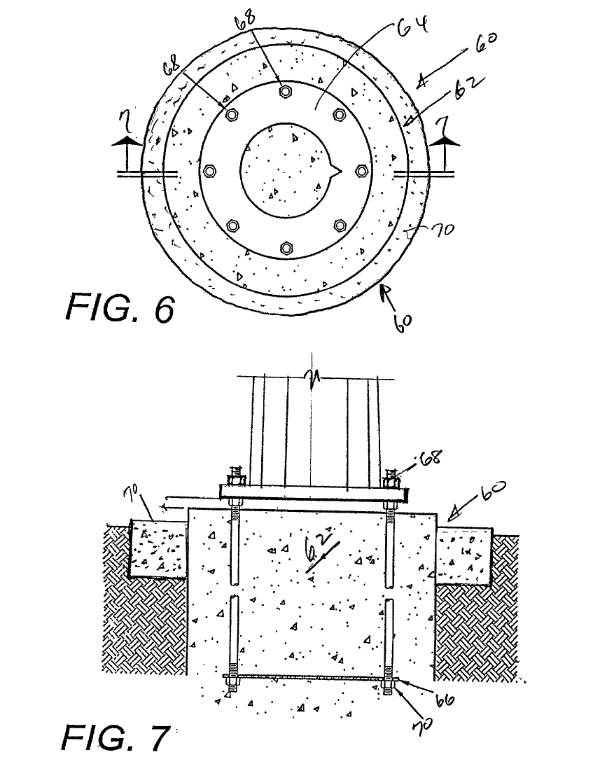

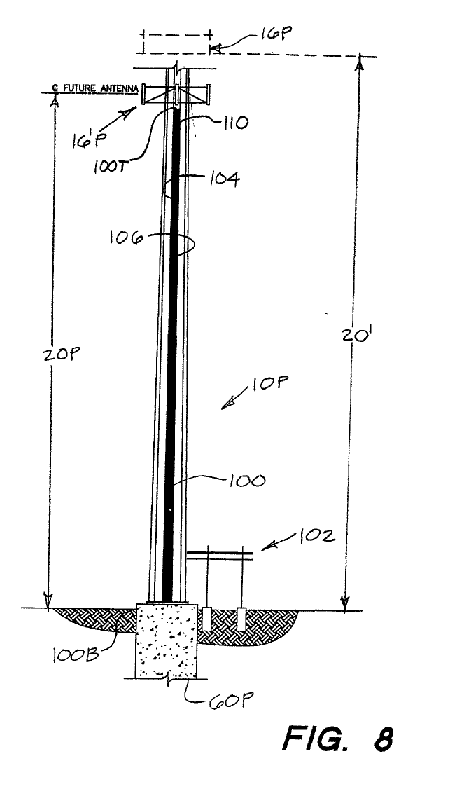

As will be understood by those skilled in the art based on the teaching of this disclosure, the steel monopole is not the only area of concern. Foundation structure 60 shown in FIGS. 6, 7 and 8 includes a central section 62 to which plates 64 and 66 are attached and on which anchor bolts 68 are mounted by nuts 70. Central section 62 is pre-existing and is placed when the pre-existing monopole is erected. In order to accommodate the extra weight and forces associated with the modified monopole, foundation 60 is modified to include a collar 70 of concrete or the like to add further stability to the foundation structure. One form of the modified foundation includes an outside diameter of eighty-four inches and a thirty foot depth, with a collar 70 of twelve inches in width and a depth of seven and one-half inches.

The base plates can be replaced or stiffened to accommodate the added forces and anchor bolts can be replaced or added to accommodate the added forces as well.

If suitable, guys, such as guy 80 indicated in FIGS. 4 and 5, can be added. The guys can be colored or the like to accommodate aesthetic considerations. Additionally, seismic considerations can be addressed in a manner that is common to such considerations, as by adding material, or special elements that can accommodate seismic events.

Additionally, the filler material includes sufficient internal as well as external passages to accommodate water as from rain, snow, or the like. Additives can also be used to meet these considerations as well as to address shrinkage, adherence and the like as will be understood by those skilled in the art based on the teaching of this disclosure.

Design criteria can be implemented in a software program so filler height, filler density, foundation structure design, economics and the like can be analyzed before a monopole is modified.

It is noted that any coaxial communication cables that are located inside an existing monopole should be removed and either moved to the outside of the monopole or be replaced by new coaxial cables on the outside of the monopole before filler material is added.

It is noted that, in the embodiments disclosed hereinbelow, the strengthening of the monopole is achieved by affixing strengthening elements, such as plates, to the external surface, or surfaces, of the monopole; whereas, the strengthening of an existing monopole discussed above has been achieved by adding strengthening material internally of the monopole.

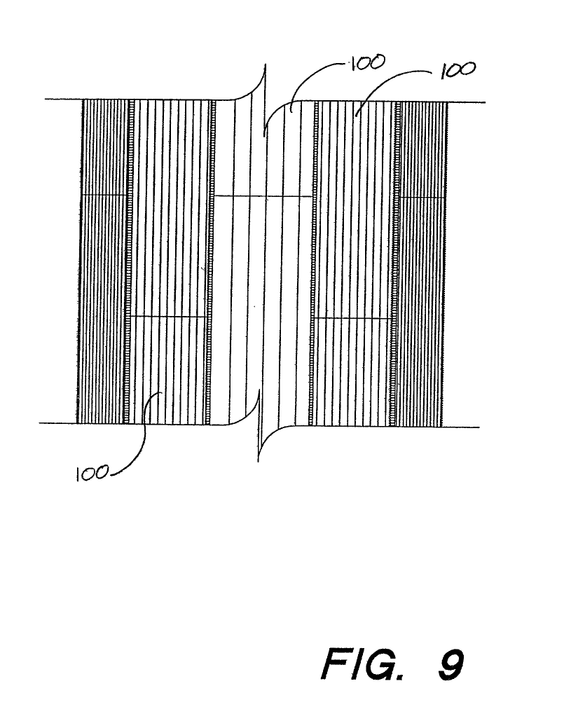

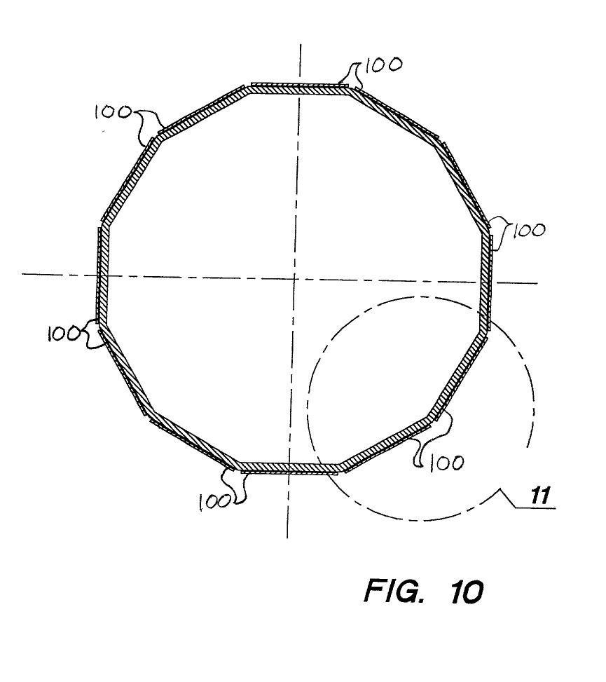

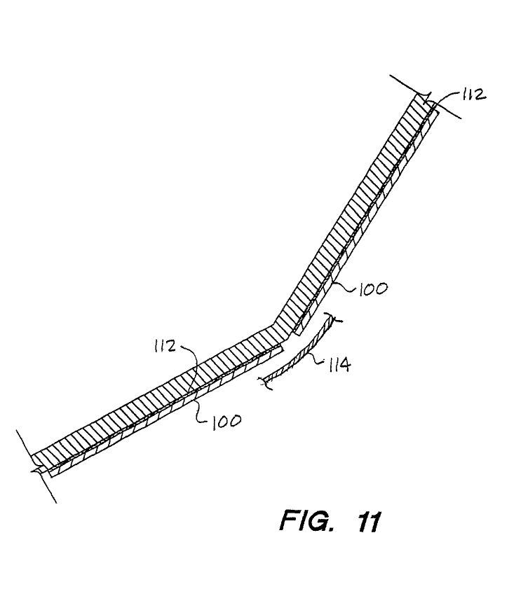

The foregoing discussion has been directed to a monopole which will be strengthened by adding filler material internally; however, some monopoles have one or more external surfaces that are amenable to accommodating strengthening elements. In fact, some monopoles can have as many as eight or twelve sides. The present invention takes advantage of this feature to increase the strength of an existing monopole. This approach is illustrated in FIGS. 9-13 in which a polygonal monopole 10P is supported by an anchor assembly 60P and has an antenna structure 16P supported thereon. As discussed above, additional antenna structures 16′P are to be added for the reasons discussed above. In order to achieve this goal, monopole 10P should be strengthened. This is achieved by fixing strengthening plates 100 to one or more faces of the polygonal monopole 10P. In one form of the invention, plates 100 are affixed to each face of the polygonal monopole. As shown in FIG. 9, a bridge structure 102 is included to support cables as they enter the monopole. As those skilled in the art will understand based on the teaching of this disclosure, such a bridge structure can be used in connection with any of the monopoles disclosed herein.

As is best shown in FIG. 9, plates 100 are formed to conform to the shape of the faces on the monopole to which they are attached. Thus, as can be seen in FIG. 9, the plates taper outwardly near the bottom of the in-place plate. That is, the width of a base plate as measured between sides 104 and 106 near the bottom 108 of the plate is greater than the width of the plate near the top 110 of the plate.

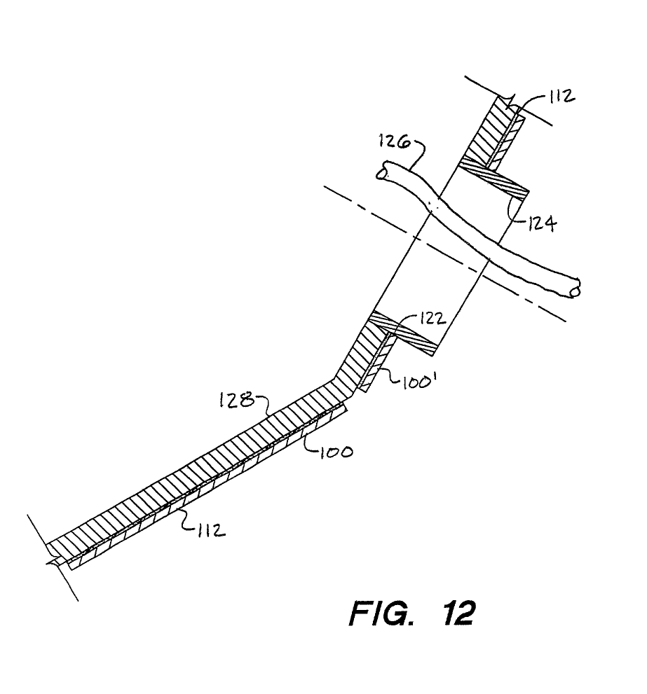

As is best indicated in FIG. 12, one method of fixing the plates to the outer surface of the monopole wall is by adhesive 112. The surface preparation required will be known to those skilled in the art based on the conditions and materials used in the monopole, the adhesive and the plates. For example, a monopole that is galvanized metal having steel plates fixed thereto will have one form of surface preparation while a painted monopole may have another form of surface preparation as well as another adhesive. A cable or band 114 can be used to encircle the plates mounted on the monopole and support those plates in position while adhesive 112 is setting up. Only a portion of the cable is shown for simplicity of illustration, but it is understood that the cable will encircle the plates and several cables can be used if necessary. The plates preferably are formed of steel, but other shapes and materials can also be used based on the requirements of a particular application. In one form of the plates, the plates are one-eighth inch thick but other thicknesses can be used without departing from the scope of the present invention.

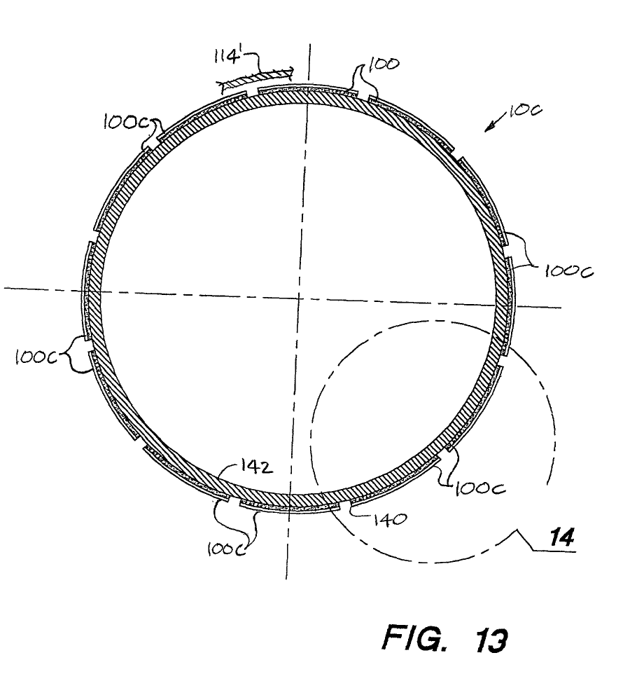

As indicated in FIG. 13, one of the strengthening plates, plate 100′, can have a bore 122 defined therethrough to accommodate an access collar 124. Cables, such as cable 126 extend into interior 128 of the monopole via collar 124. Collar 124 can be located in conjunction with bridge 102 if desired and suitable.

As discussed above, the strengthening plates can extend from adjacent to the ground in which the monopole is supported to adjacent to the level of the lowest antenna structure to be added. Thus, as illustrated in FIG. 9, a future antenna structure 16′ P will be added beneath the lowest level of existing antenna structures 16P. However, it may be possible to add antennas above the first elements. The level of the lowest existing antenna structure 16P is indicated at 20′ and the level and the level of the highest proposed antenna structure is indicated as 20P. Strengthening plates 100 are fixed to the monopole to adjacent to level 20P. That is, for example, the length of each plate 100 in the installed condition as measured from top end 100T to bottom end 100B, is essentially equal to, but can be slightly less than, distance 20P. A bottom plate 130 can encircle the bottom of the monopole if desired. The level of the top of the strengthening elements will depend on the added antennas and the specific pole and any other appropriate design criteria as will be understood by those skilled in the art based on the teaching of this disclosure.

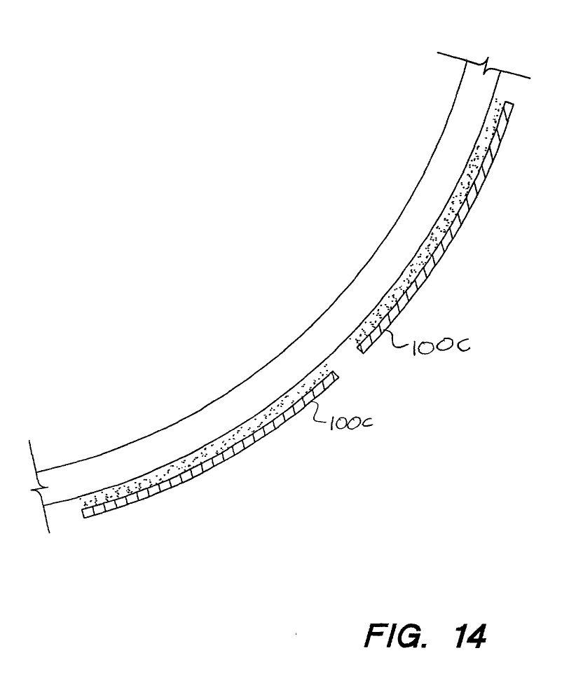

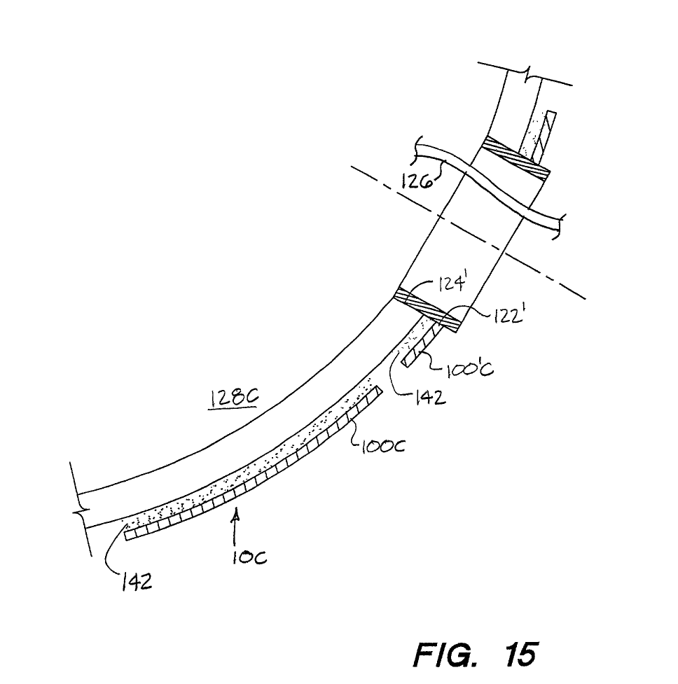

The technique in which strengthening plates are fixed to the outer surface of a wall of a monopole can be used to strengthen a monopole having a circular outer perimetric shape as well. This provides an option for strengthening a circular monopole that is in addition to the method discussed above in which concrete is placed in the hollow bore of the monopole. This second option is illustrated in FIGS. 14-16. Strengthening plates 100C are fixed to outer surface 140 of circular monopole 10C using suitable fixing means 142 to strengthen monopole 10C in the manner discussed hereinabove. Plates 100C can be steel and the fixing means can be any of the above-discussed means. Thus, suitable adhesive, or chemical bonds, or metallurgical bonds or the like can be used depending on the conditions and requirements. Plates 100C can also taper if necessary to match the shape of the existing monopole to be strengthened as discussed above with regard to monopole 10P shown in FIG. 9. A cable or band 114′ or a plurality of cables and/or bands, can also be used to secure the plates in place while the bonds between the plates and the monopole are formed and set up. The cable or band is shown spaced from the plates in FIGS. 12 and 14, but will contact those plates as necessary to hold them in place during the formation of the bond between the plates and the monopole.

As discussed above, plates 100C will extend from adjacent to the ground supporting a monopole to be strengthened, to a level adjacent to the level of the highest added antenna structure. As the case with the foregoing forms of the invention, antenna structures can be added to the monopole at levels below the level of the highest added strengthening structure. Such antenna structures will be mounted on the strengthening plates in the embodiments using strengthening plates fixed to the outer surface of the monopole. Alternatively, the level of the top ends of the plates added in either monopole 10P or 10C can be essentially equal to the level of the lowest existing antenna structure, such as level 20′ in FIG. 9. Also, the top end of internally added strengthening material in the forms of the monopole discussed in relation to FIGS. 4 and 5 can reach the level of the lowest level existing antenna structure, such as level 20 in FIGS. 1 and 2. The level of the strengthening elements in this embodiment, like that of the other embodiments, will depend on the added antennas and the specific pole and any other appropriate design criteria as will be understood by those skilled in the art based on the teaching of this disclosure.

As is the case with the polygonal monopole, one of the plates fixed to a circular monopole, plate 100′C can have a bore 122′ defined therethrough to accommodate a collar 124′ through which cables 126 extend into bore 128C of monopole 10C having a circular perimeter.

It is also noted that the external strengthening that has been discussed hereinabove can be used in conjunction with the internal strengthening discussed in association with FIGS. 4 and 5. That is, strengthening material 50 can be located inside a monopole, and strengthening plates, such as plates 100 and/or 100C can be applied to the outside of the monopole as well, depending on whether the monopole is circular or polygonal in outer perimetric shape. Thus, in appropriate circumstances, a monopole can be strengthened both internally and externally. This is indicated in FIGS. 4 and 5. While only one strengthening element is shown on each monopole, it is understood that as many as necessary can be used, and the showing of only one strengthening element is merely for the ease of illustration and is not intended to be limiting.

It is to be understood that while certain forms of the present invention have been illustrated and described herein, it is not to be limited to the specific forms or arrangement of parts described and shown.

What is claimed and desired to be secured by letters patent is as follows:

1. A monopole for supporting antennas for over-the-air communication systems comprising:
A) a hollow tubular body supported at a base end thereof in the ground and extending upwardly from the ground and supporting a plurality of first antennas thereon at various levels on said body above the ground;
B) a foundation in the ground supporting said body; and
C) filler material in said body and located above the ground supporting said body against forces exerted on at least a portion of said body.

2. The monopole defined in claim 1 wherein said filler material is selected for its strength characteristics and ability to increase the strength of the monopole.

3. The monopole defined in claim 2 wherein said filler material is one of lightweight aggregate concrete, expanding foam with aggregate and normal weight aggregate concrete.

4. The monopole defined in claim 3 further including a second antenna on said body.

5. The monopole defined in claim 4 wherein said body is filled with said filler material from said base end to a required level.

6. A method of retrofitting an existing monopole which supports first antennas for use in an over-the-air communications system comprising:
reinforcing a hollow tubular monopole which supports first antennas at various levels above the ground against forces occurring on at least a portion of one surface of the monopole by filling the hollow monopole with a filler material to a pre-determined level above the ground.

7. The method defined in claim 6 further including a step of adding a second antenna to the monopole.

8. The method defined in claim 7 wherein the pre-determined level is determined by structural analysis.

9. The monopole defined in claim 5 further including a plurality of second antennas and said body is filled with filler material to a required level.

10. The method defined in claim 8 further including adding a plurality of second antennas to the monopole.

11. The method defined in claim 10 wherein the pre-determined level is determined by structural analysis.

12. The monopole defined in claim 1 wherein said filler material is selected for its stiffening characteristics and ability to decrease deflection of the monopole.

13. The monopole defined in claim 1 wherein said body includes an external surface and further includes strengthening elements located on the external surface of said body.

14. The monopole defined in claim 13 wherein said foundation includes anchor bolts and a collar.

15. The method defined in claim 6 wherein the step of reinforcing a hollow tubular monopole includes a step of fixing strengthening elements to an external surface of the monopole.
